(19) United States
(12) Patent Application Publication
(10) Pub. No.: US 2007/0079288 A1
(43) Pub. Date: Apr. 5, 2007

(54) System and method for capturing filtered execution history of executable program code

(76) Inventors: Chad Willwerth, Puyallup, WA (US); Shad Muegge, Redmond, WA (US); Suresh Dithiraru, Tumwater, WA (US); Christian Iovin, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/242,302

(22) Filed: Sep. 30, 2005

(51) Int. Cl. G06F 9/44

(52) U.S. Cl. 717/124

(57) ABSTRACT

A method and system to validate executable program code are provided. The system comprises a custom handler residing on a target component, a validation tool residing on a host system, and a debug port on the target system to provide communication between the target component and the validation tool via a plurality of debug pins. The custom handler may be configured to commence collecting and processing execution data for the executable program code responsive to detecting a triggering event at the target system, while the debug tool may be configured to provide instructions to the custom handler of what data to capture and to receive the data captured by the custom handler.

### BACKGROUND

1. Technical Field

One or more embodiments of the invention generally relate to validation and verification of executable program code. In particular, certain embodiments relate to capturing filtered execution history of executable program code.

2. Description of Related Art

Debug tools are important for both integrated circuit (IC) and general system-level analysis. Design validation and verification (or debugging) is now an integrated part of the processor and chipset design process.

Some techniques currently used to debug processors either require considerable expenditure of funds or are inefficient. For example, in order to follow the code flow within a processor, a user may utilize a logic analyzer to capture addresses transmitted across the processor memory bus. A logic analyzer captures digital data from a digital system such as a processor and makes it available for examination. Based on this captured data, a validation engineer may be able to locate a point of failure in the processor's executable program code. Logic analyzers, however, may be extremely expensive, which may impact the overall cost of processor and chipset validation.

In some systems additional circuitry may be added to the processor core to be utilized for debugging purposes. For example, such additional circuitry may be adapted to capture a small number branches at a time. According to this technique, the processor has to be stopped in order to view execution data. The “stopped” state of a processor is sometimes referred to as “full interrogation” or a “debug mode.” Once the processor is stopped, the data is dumped so that a validation engineer may view this data. The processor then needs to be restarted. This approach, while being time consuming, may also produce excessive and not necessarily relevant data for a validation engineer to analyze.

Alternatively, processor code may be instrumented with output statements in order to isolate and resolve a problem. The task of developing and debugging output statements, recompiling the code, and then removing the statements once the problem is resolved is often slow and tedious and may mask some issues.

Another approach to debugging a processor includes using in-circuit emulators. A typical in-circuit emulator provides a processor emulation module that emulates processor functions for a target computer system. A host computer controls the emulation functions. A processor emulation module is usually inserted into the target computer system in place of the target processor and can be used to emulate the functions of the target processor according to user commands entered at the host computer. Such emulators, while being relatively slow, may also not be capable of revealing problems that only manifest themselves during real-time operation.

One other method to view the code execution trace of a processor is to step through the code manually. Considering the speeds at which the instructions are processed by a processor in real time and the volume of instructions that a validation engineer may possibly have to step through, this method is rarely efficient enough to be acceptable.

### BRIEF DESCRIPTION OF THE DRAWINGS

The embodiments of the invention are illustrated by way of example and not limited by the accompanying drawings, in which like references indicate similar elements and in which:

FIG. 1 is a diagrammatic representation of a system for capturing filtered execution history of executable program code, according to an embodiment of the invention.

FIG. 2 is a flow chart of a method for capturing and processing execution history of executable program code, according to an embodiment of the invention;

FIG. 3 is a flow chart of a method for branch coalescing, according to an embodiment of the invention;

FIG. 4 is a flow chart of a method for tracking specific branch instructions, according to an embodiment of the invention; and

FIG. 5 is a diagrammatic representation of a computer system, within which a set of instructions, for causing the machine to perform any one or more of the methodologies discussed herein, may be executed.

### DETAILED DESCRIPTION

In one embodiment, the invention may advantageously utilize an In-Target Probe (ITP) product, which is a software and hardware debug tool that may be used by validation and test engineers for processor and chipset validation. For the purposes of this description, an ITP is used to refer to any debug tool that may reside on a host computer system while being capable of controlling a component under test residing on a target computer system. It will be noted, that for the purposes of this description, the term “validation” is used to encompass the process of “debugging.”

The ITP may be used to validate various components such as a new microprocessor, a chipset, or an executable program code running on a component. and to isolate various problems, e.g., system, compatibility, and software problems. A component that is the target of the validation process may be referred to as a target component. For example, a user (such as a validation engineer) may utilize an ITP to capture and display execution data of interest. In one embodiment of the invention, the execution data may be provided to the user as it is being captured.

An ITP may plug into a debug port of the computer system that houses the target component (a target system) so that it can control the target system. An ITP may provide a graphical user interface, full interrogation and control of the processor, as well as access to various sections within a microprocessor, such as registers, memory, and Input/Outpu (IO) via the Test Access Port (TAP). An ITP, or any other debug tool, may also provide Joint Test Action Group (JTAG)/debug port access (or other debug bus access) to the processor or chipset's debug features.

In order to increase efficiency of the validation and verification process, the method and system may be provided to permit a user (e.g., a validation engineer) to execute ITP test cases on the target component without the need to stop and restart the target execution.

According to one embodiment, an ITP residing on a host computer system provides a custom microcode patch to the target system. The patch, which may be utilized as a custom handler in the target system, may be designed to capture filtered execution data at the target system and to provide the captured data to the host system while the executable program code on the target system (e.g., the target CPU or a chipset) is still running. The execution data may be captured according to filtering criteria provided with the custom microcode patch. For example, a custom handler may be configured to capture only particular data, e.g., data associated with input/output (I/O) accesses, a particular CPU register access (such as model specific register (MSR) accesses), execution history, or traces of a particular symbol, or a particular virtual memory region.

In one embodiment, the custom handler may be capable of processing captured data, in order to control the amount of captured data that is to be retained and sent to the host system. For example, the custom handler may be configured (e.g., by means of providing it with a particular microcode patch) to coalesce redundant execution data, even if part of the data, such as the destination address of a branch instruction, is missing, so that the volume of execution data available to validation engineers is more manageable.

In some embodiments, post processing techniques may also be provided with an ITP. Post processing techniques may include, for example, comparing two execution traces and generating indicators to provide the count of how many times a particular condition has been encountered by the custom handler running at the target component. In another embodiment, a post processing component may be provided to examine the processed execution data and to count occurrence of data indicative of a particular condition. Another exemplary post processing technique may include determining the differences between two sets of execution data.

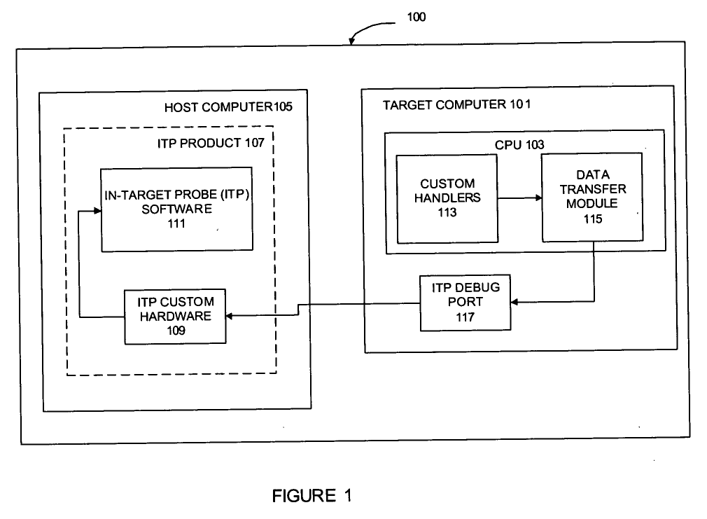

FIG. 1 is a diagrammatic representation of a system 100 for capturing filtered execution history of executable program code, according to an embodiment of the invention. The system 100 comprises a target computer 101 with a CPU 103 that is the subject of debug and validation procedures and a connector to connect a debug tool such as an In-Target Probe (ITP) 107. It will be noted, that, although FIG. 1 shows a CPU as a target component, a target computer may include other possible silicon components being debugged, such as chipsets, for example. The ITP debug tool comprises a hardware component (ITP hardware) 109 and a software component (ITP software) 111. The target CPU 103 comprises, in one embodiment, a custom handler 113 and a data transfer component 115. The target CPU 103 may be, for example, an IA-32 Intel® processor, an Itanium® Processor Family (IPF) Intel® processor, or some other chipset device or gaming chip, or a non Intel® device.

A debug port 117 may connect the target 101 to the ITP hardware 109. As will be understood by a person having ordinary skill in the art, such a connection may enable logic signals to be transmitted from the target 101 to the host 105, e.g., via a plurality of debug pins that are driven by the target CPU 103.

In an exemplary embodiment of the invention, the host 105 may be any computer for supplying ITP hardware and/or software for enabling debugging. The target 101 may be a debug platform including a target component such as a processor and/or a chipset (e.g., the CPU 103).

In an exemplary embodiment of the invention, the host 105 may include a display (not shown) for displaying a debugging software program. As will be understood by a person having ordinary skill in the art, a command line interface (CLI) and/or a graphical user interface (GUI) may be included with the debugging software program, through which a user may control test case execution, e.g., specify filtering criteria and the types of data to collect at the target. Additionally, the host 105 may include other input/output (I/O) devices, such as a keyboard, a mouse, or the like.

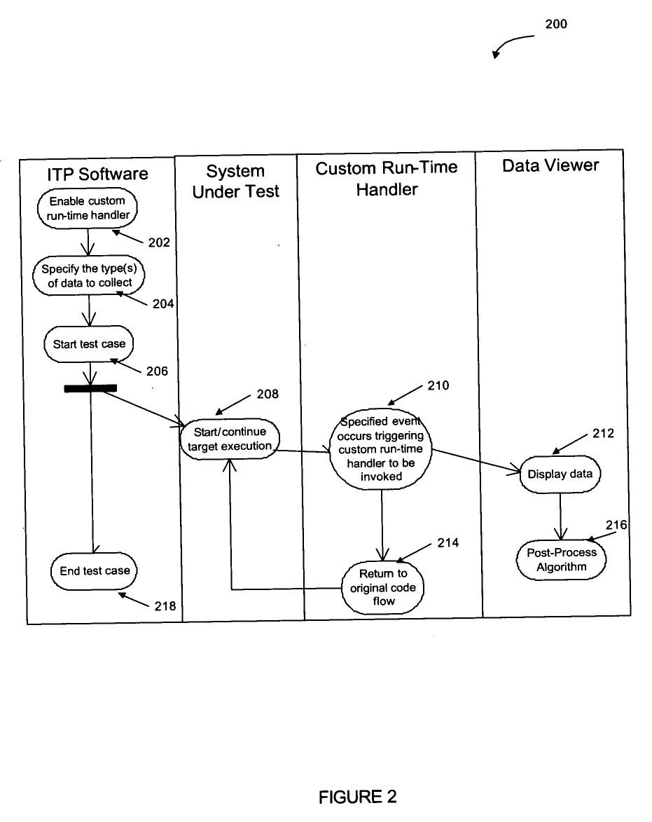

FIG. 2 illustrates a method 200 for capturing and processing execution history of executable program code, according to an embodiment of the invention. The method may be performed by processing logic that may comprise hardware (e.g., dedicated logic, programmable logic, microcode, etc.), software (such as software that can be run on a general purpose computer system or a dedicated machine), or a combination of both.

In one embodiment, the debugging process starts by a user (e.g., a validation engineer) enabling the custom handler 113 via the ITP 107. The custom handler 113 may be implemented as a microcode patch designed to detect particular events associated with the target executable program. The microcode patch may be delivered to the target computer system 101. The custom handler 113 may then intercept particular data of interest (such as I/O and MSR accesses, branches, interrupts, etc.). At block 202, the ITP 107 enables the custom handler 113. The custom handler may be configured to indicate what particular data is to be collected from the target CPU 103 (block 204). Once the custom handler 113 is enabled and the types of data to be collected from the target CPU 103 are specified, a test case may be started on the ITP 107 at block 206.

According to the illustrative method 200, while the test case runs on the ITP 107, the custom handler 113 is invoked every time a particular event occurs (block 210). Those events that should trigger the custom handler 113 may be specified through the ITP 107.

Once the custom handler 113 is invoked, it intercepts only execution data associated with the triggering event and sends the intercepted data out to the ITP debug port 107 via the transfer module 115. From the ITP debug port 107 the data is communicated to the ITP 107 so that it can be collected and possibly displayed to the user (block 212). This process of intercepting data responsive to a triggering event and transferring the intercepted data to the debug tool running on the host repeats while the test case is running (block 214), and until the test case ends (block 218).

At block 212, the data received from the custom handler 113 is displayed, at an ITP data viewer, to the user who monitors the execution of the test case.

As noted above, the user may specify different types of events that should invoke the custom handler 113. Such triggering events may, for example, include every branch instruction encountered by the custom handler 113, specific branch instructions (e.g., calls or jumps), I/O accesses, or some other specific type of assembly macro- or micro-instruction being executed (e.g., MSR accesses, such as READMSR and WRITEMSR).

In a case where the custom handler 113 utilizes a microcode patch that is designed for branch collection, in one embodiment, when the custom handler 113 detects a branch instruction, it captures the associated source and destination addresses and writes these addresses to one of Last Branch Registers (LBRs). Here, the branch instruction is detected by the custom handler 113 every time a branch is taken in the executable program code running on the CPU 103. A custom handler that is designed for branch collection may also be referred to as an LBR microcode patch or a BTM (Branch Trace Messages) microcode patch depending on whether it writes the branch data to a register or to memory.

The format of LBRs or BTMs may vary depending on a particular processor or a particular chipset. In some embodiments, separate registers in the target processor (e.g., the CPU 103) may be used for the source and the destination addresses. In other embodiments, memory may be used for storing the source and the destination addresses. Alternatively, the source and the destination addresses may be both written to the same register with the source address stored in the one half and the destination address stored in the other half. A processor may have multiple LBRs (e.g., 4, 16, or 32).

In one embodiment, where a user is interested in branch collection at the target CPU 103, the user loads the LBR microcode patch in the ITP 107 first, then the ITP 107 sends the LBR microcode patch to the processor 103 via the debug port 117 so that the user may begin debugging on the target system 101. Each time the source and the destination addresses are written to an LBR at the target CPU 103, the custom handler 113 (implemented as the LBR microcode patch) intercepts the associated execution data. The intercepted data is then transferred, via the data transfer module 115 and via the debug port 117, to the ITP 107 for further examination by a user controlling the ITP 107. In one embodiment of the invention, the intercepted data is being transferred to the ITP 107 only if it is determined to be different from previously transferred data.

In another embodiment, the custom handler 113 may be implemented by what may be termed an I/O microcode patch. An I/O microcode patch may be generated to allow the custom handler 113 to intercept either any access instruction encountered at the target CPU 103 or only specific types of access instructions such as MSR access instructions.

Where an I/O microcode patch is utilized, according to one embodiment, the ITP 107 sends the microcode patch to the processor 103 via the debug port 117 and the custom handler 113 commences intercepting each I/O access instruction at the processor (e.g., the CPU 103). As the custom handler 113 is intercepting the I/O access instructions, the intercepted data is being transferred, via the data transfer module 115 and via the debug port 117, to the ITP 107 for further examination by a validation engineer controlling the test case.

In still another embodiment, a custom handler may be implemented as a microcode patch for capturing only traces of a particular program symbol, e.g. a program variable or a memory region where a part of a program is loaded. The user may indicate that the associated microcode patch is to detect address ranges for certain symbols within the target executable program code.

When the microcode patch designed for capturing traces of a particular symbol is delivered to the target CPU 103, and while the test case runs, the custom handler 113 may intercept each memory access the processor performs and compare it to the address ranges designated by the microcode patch. When a match is detected, the target CPU 103 may send the current address and the associated data out to the ITP debug port 117 via the data transfer component 115. The data is then delivered to the ITP 107 for further examination by a user. This process of intercepting each memory access the CPU 103 performs and comparing it to the address ranges designated by the microcode patch repeats while the test case is running (block 208 of FIG. 2), and until the test case ends (block 218).

In some execution scenarios, processor's execution data captured by the custom handler 113 may be duplicative or irrelevant. For example, when a processor under test executes a loop, the custom handler 113 may capture excessive amounts of data that may not be entirely useful for debug purposes. It may be beneficial, in some embodiments, to configure the custom handler 113 to examine the captured data before it is transferred to the ITP 107, and discard the captured data if the data is determined to be redundant.

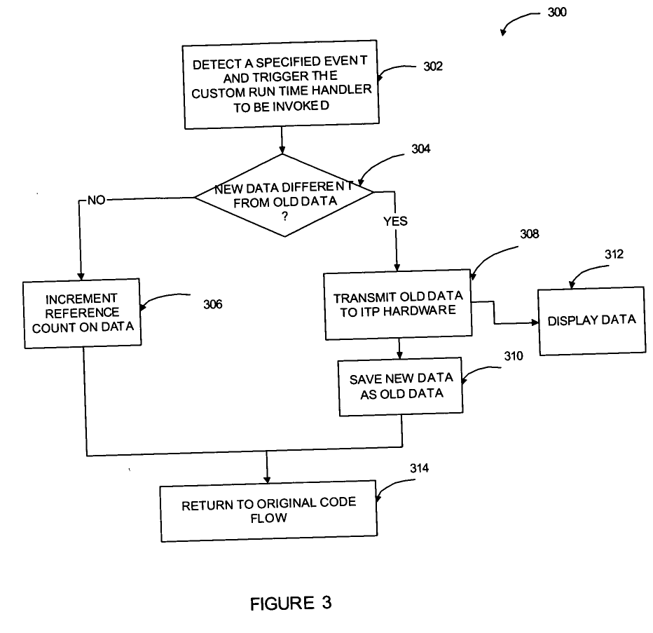

FIG. 3 is a flow chart of a method 300 for branch coalescing, according to an embodiment of the invention. The method may be performed by processing logic that may comprise hardware (e.g., dedicated logic, programmable logic, microcode, etc.), software (such as run on a general purpose computer system or a dedicated machine), or a combination of both.

In one embodiment, when a specified event triggers the custom handler 113 to capture execution data at block 302, the custom handler 113 compares, at block 304, the new data (the data that has just been captured) to data that was captured earlier (the old data). If it is determined, at block 304, that the new data is different from the old data, the old data is transmitted (block 308), via the data transfer module 115 and via the debug port 117, to the ITP 107 running at the host 105 so that it can be displayed to the user (block 312). The new data is then stored as the old data in preparation for the start of the next coalescing cycle (block 310). If it is determined, at block 304, that the new data is the same as the old data, the new data is discarded (or flushed). The custom handler 113 in this case increments the reference count on captured data (block 306), and returns to the original code flow (block 314).

In one embodiment, where, for example, an LBR custom patch is utilized, the LBR custom patch intercepts each source/destination addresses pair while a test case is being executed. If the intercepted source/destination addresses are the same as in the previous source/destination addresses pair, they are not written out to the ITP 107 but are flushed instead. The reference count is incremented and the custom handler 113 continues with the code flow. If both the source and the destination addresses are unique, they are not discarded, but instead are sent out to the ITP debug port 117 for display to the user controlling the test case. The process of the custom handler 113 intercepting each source/destination addresses pair and comparing them with the previous source/destination addresses pair repeats while the user's test case is running. While the test case is running, the user may be permitted to view execution data transmitted from the custom handler 113 at a data viewer of the ITP 107 rather than stopping execution.

The method 300, in some embodiments, may be generalized to apply to data being written out to the ITP debug port 117, as well as to data being written to an internal register at the target CPU 103 for further communication to a debug tool (e.g., the ITP 107).

In one embodiment, duplicative data that is being captured by the custom handler 113 may be coalesced even when the source/destination addresses pair data is incomplete. For example, a source address may not have an associated destination address (e.g., data appears in a trace as two source addresses back to back) or a destination address may not have an associated source address. In order to handle these situations, the existence of the stored source addresses and the stored destination addresses may be tracked independently.

Thus, address coalescing may be achieved by tracking the existence of each piece of data independently (e.g., by tracking whether or not the source and destination addresses have each been detected). Each new piece of data is compared to a corresponding old piece of data (e.g., both source and destination addresses are being compared to the old data independently). The custom handler 113 may also be configured (via an appropriate microcode patch) to check for changes in address type, because two addresses of different types having the same value may still be considered to be different. For example, virtual and physical addresses with the same value should be treated, in some embodiments, as different addresses, as the virtual and the physical addresses with the same value may be located in two different physical locations. When two addresses are determined by the custom handler 113 to be the same (or, in other words, if a match occurs), a counter for that piece of data for that address is incremented. Alternatively, any time any of the data that has been stored by the coalescing algorithm (the old data) does not match the new data, or data existence criteria is mismatched, the stored data is transmitted across the debug pins of the debug port 117 to the ITP 107. The coalescing state indicator is reset, and the new data is stored to start the next coalescing cycle.

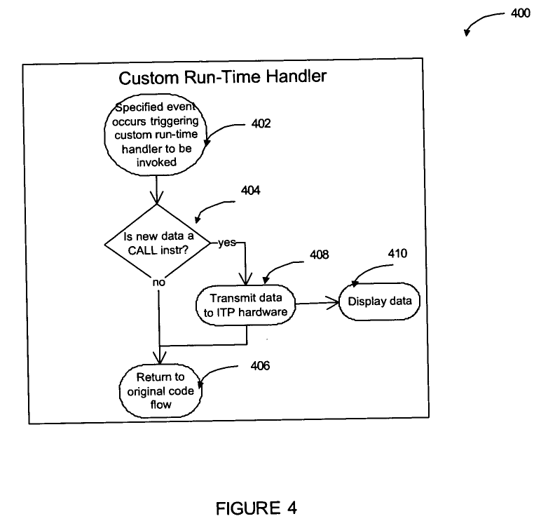

FIG. 4 is a flow chart of a method 400 for tracking specific branch instructions, according to an embodiment of the invention. The method may be performed by processing logic that may comprise hardware (e.g., dedicated logic, programmable logic, microcode, etc.), software (such as run on a general purpose computer system or a dedicated machine), or a combination of both.

In one embodiment, when a specified event triggers the custom handler 113 to capture data at block 402, the custom handler 113 determines if the captured data is associated with a specific branch instruction, here a CALL instruction (block 404). If the captured data is associated with a CALL instruction, the execution data associated with this CALL instruction is transmitted to the debug port 117 via the data transfer component 115. The data is then delivered to the ITP 107 (block 408) for further examination by a user (block 410). Otherwise, if the captured data is not associated with a CALL instruction, the custom handler 113 returns to the original code flow (block 406).

Similarly, in another embodiment, the data to be captured by the custom handler 113 may include JMP instructions. In this case, a microcode patch implemented as the custom handler 113 to capture data associated with JMP instructions may be referred to as a JMP microcode patch. In this embodiment, the presence of a JMP instruction triggers the custom handler 113 to be invoked. The custom handler 113 determines if the captured data is associated with a JMP instruction. If the captured data is associated with a JMP instruction, the execution data associated with this JMP instruction is transmitted to the debug port 117 via the data transfer component 115. The filtered data is then delivered to the ITP 107 for further examination by a user. If the captured data is not associated with a JMP instruction, the custom handler 113 returns to the original code flow.

When the microcode patch designed for capturing traces of a particular virtual memory region is delivered to the target CPU 103, and while the test case runs, the custom handler 113 may intercept each memory access the processor performs and compare it to the virtual memory address ranges designated by the microcode patch. When a match is detected, the target CPU 103 may send the current address and the associated execution data out to the ITP debug port 117 via the data transfer component 115. The data is then delivered to the ITP 107 for further examination by a validation engineer controlling the ITP. This process of intercepting each memory access the CPU 103 performs and comparing it to the address ranges designated by the microcode patch repeats while the test case is running (block 212 of FIG. 2), and until the test case ends (block 218).

It will be noted, that the data provided to the ITP 107 from the custom handler 113 may be processed further, e.g., to allow a user to narrow the focus of the debug analysis even more. For example, the post processing may include, in one embodiment, determining the differences between two trace runs performed on two separate target CPU 103 or two separate runs on the same target CPU 103. The post processing may also include counting how many times a particular instruction, such as a JMP, a CALL, an I/O access, a symbol access, or traces of a particular (Virtual Machine Extensions) VMX region are generated and displaying the results to a user as indicators.

In order to perform post-processing to compare different traces, in one embodiment, two instruction traces that have been sent across the debug port 117 to the ITP 107, are compared side-by-side, and any divergence between the two traces are displayed in the data viewer of the ITP 107. The two traces that are the subject of comparison may represent, for example, two execution runs performed on different steppings of a processor (e.g., the CPU 103).

Post-processing may be utilized, in one embodiment, to generate indicators for particular types of instructions. For example, a user may enable a flag, within a post-processing test script, associated with each parameter for which the user is interested in data mining. For example, the parameters that can be flagged within a test script may include branches, jumps, READMSR accesses, I/O accesses, etc. For each piece of data that comes across the debug port 117, the ITP 107 may then compare this piece of data with the set of flags in the test script. If the condition matches, a counter for an appropriate flag may be incremented. The results may then be displayed to the user.

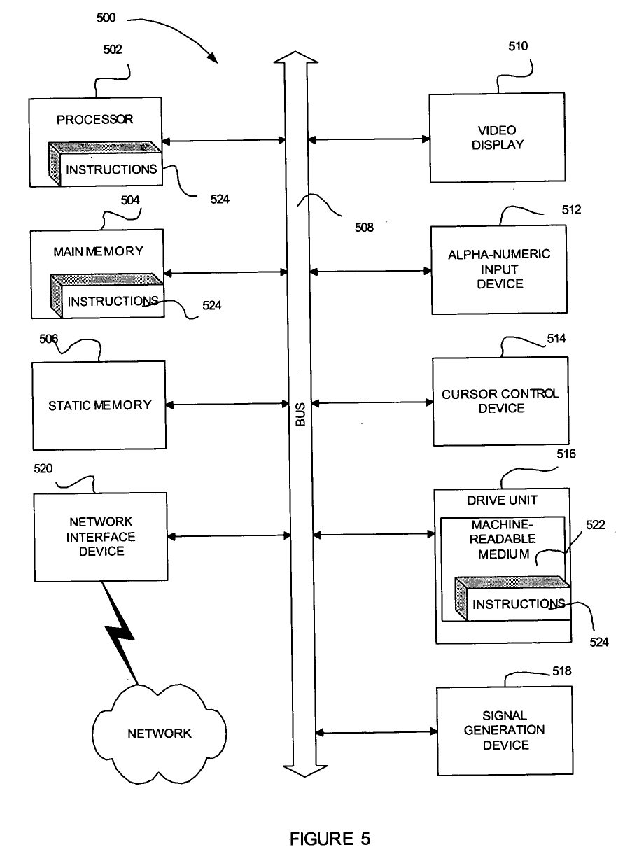

FIG. 5 shows a diagrammatic representation of a machine in the exemplary form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processor 502 (e.g., a central processing unit (CPU) a graphics processing unit (GPU) or both), a main memory 504 (a memory in which information is stored capacitively) and a static memory 506 (a memory in which the basic cell circuit consists of a flip-flop), which communicate with each other via one or more buses 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520.

While the machine-readable medium 522 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the invention. The term “machine-readable medium” shall accordingly be taken to include, but not be limited to, solid-state memories, optical and magnetic media, and carrier wave signals.

Thus, a method and system for capturing filtered execution history of executable program code have been described. Although the method and the system have been described with reference to specific exemplary embodiments, it will be evident that various modifications and changes may be made to these embodiments without departing from the broader spirit and scope of the disclosure. Accordingly, the specification and drawings are to be regarded in an illustrative rather than a restrictive sense.

1. A system to validate executable program code, the system comprising:
a custom handler residing on a target component to:
detect a triggering event, and
responsive to detecting the triggering event, commence collecting and processing execution data for the executable program code; and
a validation tool to:
enable the custom handler,
send the custom handler to the target system, and
receive the processed execution data; and
a debug port on the target system, comprising a plurality of debug pins, to:
provide communication between the target component and the validation tool via the debug pins.

2. The system of claim 1, wherein the custom handler is to determine a type of data to collect while the executable program code is running.

3. The system of claim 2, wherein the type of data to collect comprises input output (I/O) accesses.

4. The system of claim 2, wherein the type of data to collect is selected from the group consisting of:
data associated with model specific register (MSR) accesses;
data associated with JMP instructions;
data associated with CALL instructions;
data associated with a symbol; and
data associated with a virtual memory region.

5. The system of claim 2, wherein the type of data to collect comprises execution history.

6. The system of claim 1, wherein the custom handler is to process the execution data by coalescing redundant execution data.

7. The system of claim 6, wherein the custom handler to process the execution data by coalescing redundant data is to:
intercept a current address associated with the executable program code; and
identify data associated with the current address as being designated for communicating to the host system only if the current address is different from the previous address.

8. The system of claim 7, wherein the current address is a source address or a destination address.

9. The system of claim 7 wherein the current address is different from the previous address if the type of the current address is different from the type of the previous address.

10. The system of claim 1 further comprising a data transfer module residing on the target component to communicate the processed execution data to the host system while the executable program code is running on the target component.

11. The system of claim 1 further comprising a data viewer to display the processed execution data received by the validation tool.

12. The system of claim 1 further comprising a post-processing module to determine differences between two sets of execution data.

13. The system of claim 12, wherein the post-processing module is to determine differences between two sets of execution data with respect to a particular parameter.

14. The system of claim 12, wherein the post-processing module is to count occurrence, in the processed execution data, of data indicative of a particular condition.

15. The system of claim 12, wherein target component is an integrated circuit (IC) comprising a processor or chipset.

16. A computer-implemented method to debug executable program code, the method comprising:
detecting a target event associated with the executable program code running on the target system; and
responsive to detecting the target event, commencing collecting and processing execution data for the executable program code; and
communicating the processed execution data to the host system.

17. The method of claim 16, further comprising enabling a custom handler provided at the target system.

18. The method of claim 16, further comprising specifying a type of data to collect from the executable program code.

19. The method of claim 16, wherein processing the execution data comprises coalescing redundant data from the execution data.

20. The method of claim 19, wherein coalescing redundant data from the execution data comprises:
intercepting a current source/destination address pair associated with the executable program code; and
identifying data associated with the current source/destination address pair as being designated for communicating to the host system only if the current source/destination address pair is different from the previous source/destination address pair.

21. The method of claim 20, further comprising incrementing a counter and intercepting a new source/destination address pair if the current source/destination address pair is the same as a previous source/destination address pair.

22. The method of claim 19, wherein coalescing redundant data from the execution data comprises:
intercepting a current address associated with the executable program code; and
identifying data associated with the current address as being designated for communicating to the host system only if the current address is different from the previous address.

23. The method of claim 22, wherein the current address is a source address or a destination address.

24. A machine-readable medium having stored thereon data representing sets of instructions which, when executed by a machine, cause the machine to:
detect a triggering event utilizing a custom handler at a target system;
responsive to detecting the triggering event, commence collecting execution data for the executable program code;
communicate the collected execution data to a host system while the executable program code is running on the target system.

25. The machine-readable medium of claim 24 having stored thereon data representing sets of instructions which, when executed by a machine, cause the machine further to determine a type of data to collect while the executable program code is running.

26. The machine-readable medium of claim 24 having stored thereon data representing sets of instructions which, when executed by a machine, cause the machine to process the execution data by coalescing redundant data from the execution data.
